(19) United States
(12) Patent Application Publication
(10) Pub. No.: US 2020/0391401 A1
(43) Pub. Date: Dec. 17, 2020

(54) MATERIAL DISTRIBUTING DEVICE FOR SPONGE CUTTING MACHINE

(71) Applicant: NANTONG MUYE MACHINERY CO., LTD., Nantong City, Jiangsu (CN)

(72) Inventor: Xiaolong MIAO, Jiangsu (CN)

(21) Appl. No.: 16/763,967

(22) PCT Filed: Aug. 8, 2018
(86) PCT No.: PCT/CN2018/099296

§ 371 Date: May 13, 2020

(30) Foreign Application Priority Data
Aug. 7, 2018 (CN) 201810891573.6

(51) Int. Cl. B26D 7/18; B26D 7/32

(52) U.S. Cl. CPC B26D 7/1863; B26D 7/32

(57) ABSTRACT

A material distributing device for sponge cutting machine, which distributes materials for sponge cutting machine, including a plurality of vacuum suckers, the vacuum suckers are respectively connected with the independently arranged vacuum suction device through the air pipe, and the sponge blocks which has been cut are sucked by the vacuum suckers to conduct material distribution. The design is reasonable and the structure is simple. By using of the vacuum suckers to suck the sponge blocks at the corresponding position, and the lifting of the sponge blocks is driven by the lifting of the pressing frame, so as to realize the material distribution, and, the material distribution is neat.

### CROSS REFERENCE TO RELATED APPLICATION

This application is a continuation of International Patent Application No. PCT/CN2018/099296, filed on Aug. 8, 2018, which claims priority benefit of Chinese Patent Application No. 201810891573.6, filed on Aug. 7, 2018, and the entire contents of which are incorporated herein by reference.

### TECHNICAL FIELD

The present invention relates to the technical field of sponge cutting, in particular to a material distributing device for sponge cutting machine.

### BACKGROUND

The sponge flat cutting machine can only cut the sponge horizontally, while the longitudinal cutting needs another cutting tool for cutting, so that it requires vertically cutting the sponge in advance, and then transporting the cut sponge blocks to another cutting tool through the material distributing mechanism. In the past, the material distributing structure was designed as a material distributing and conveying device on the sponge flat cutting machine (such as the patent: CN201510221650.3, the material distributing and feeding mechanism mentioned in the sponge flat cutting machine with rotatable slice and material distributing and feeding), or an independently material distributing and feeding device (a material distributing device for sponge cutting, an independently designed material distributing device, combined with a double-elevating conveying mechanism, capable of cooperating with conveying platforms with different heights, and docking different sponge cutting machines). This material distributing device uses the transmission mechanism with a shovel plate to divide the material. After the material is divided, the sponge blocks are arranged unevenly.

Patent application publication number: CN106625860A, a full-automatic sponge cutting machine, in order to achieve its material distribution function to set up the above material distributing device, which will occupy large space and require high cost.

### SUMMARY

The present invention is to provide a material distributing device for sponge cutting machine. The design is reasonable and the structure is simple, by using of the vacuum suckers to suck the sponge blocks at the corresponding position, and the lifting of the sucked sponge blocks is driven by the lifting of the pressing frame, so as to realize the material distribution, and the material distribution is neat. For CN106625860A, a fully-automatic sponge cutting machine, which directly adds a vacuum sucker on its pressing device, does not affect its pressing function, but also increases the material distribution function, which occupies little space and has low cost.

### The Technical Solution of the Present Invention

A material distributing device for sponge cutting machine, including, a plurality of vacuum suckers, wherein the vacuum suckers are respectively connected to the independently arranged vacuum suction device through air pipes, and, the sponge blocks which has been cut are sucked by the vacuum suckers to conduct material distribution.

When the material needs to be distributed and discharged, some of the sponge material blocks is sucked through the vacuum suckers, and the rest of the sponge material blocks continues to be transported out by the sponge cutting machine. After that, the sponge material blocks sucked is put down by the vacuum suckers and transported out by the sponge cutting, machine, to achieve the object of material distribution, Or, using of a robot independent set or directly fixed on the sponge cutting machine, and the vacuum suckers are fixedly installed on the hand of the robot, the vacuum suckers are configure for sucking and the transportation is realized by the robot to achieve the object of material distribution. By using of the vacuum suckers to suck the sponge material blocks, no horizontal force will be generated when material distribution, and the sponge blocks after material distribution are arranged neatly.

To further improve and refine the above technical solution, the sponge cutting machine is a fully automatic sponge cutting machine, its patent application publication number: CN106625860A, the fully automatic sponge cutting machine includes a pressing device; the pressing device includes a vertical bracket, a horizontal bracket, a guide rail, a slider, a rotating shaft, a transmission shaft, a driving motor, a pulley, a synchronous belt, and a shrinkage bracket; a lower end of the vertical bracket is connected to the worktable base; there are designed four vertical brackets, two the horizontal brackets; the two horizontal brackets are installed in parallel between the two adjacent vertical brackets; vertical guide rails are installed on one side of the vertical bracket, vertical sliders are installed on both ends of the horizontal brackets, the vertical sliders are snapped in the vertical slide rails in sliding fit; upper and lower ends of the vertical brackets are equipped with rotating shafts and the rotating shafts are equipped with pulleys, upper and lower ends of the pulleys are equipped with the synchronous belt, one side of the synchronous belt is fixed to one side of the vertical slide rails, wherein the rotating shafts at upper ends of the two vertical brackets on the adjacent side are connected by the transmission shaft, and an outer end of one of the rotating shafts is connected to the driving motor, the driving motor is installed on the vertical bracket, a plurality of shrinkage brackets and one fixed connection support are provided between the two horizontal brackets, two ends of the shrinkage bracket are provided with a horizontal slider, a horizontal guide rail is installed in an inside of the horizontal bracket, the two ends of the shrinkage bracket are snapped in the horizontal guide rail by the horizontal slider in sliding fit, the fixed connection support is fixed between the two horizontal brackets and is located in the same end of the two horizontal brackets, positions near ends of the plurality of shrinkage brackets are respectively foldably connected to each other by a crossing connection rod, and a last end of the crossing connection rod is fixed on the fixed connection support, the rotating shafts are installed at both ends of the horizontal slide rails, and pulleys are installed on the rotating shafts, the synchronous belt is installed around the pulleys on the same horizontal slide rail, one side of the synchronous belt is fixed to one side of the horizontal slider, the rotating shafts on one side of the two horizontal slide rails near the fixed connection support are connected to each other by the transmission shaft, and the transmission shaft passes through the fixed connection support, at the same time, one of the rotating shafts is equipped with the driving motor at an outer side, the vacuum suckers are evenly arranged on bottoms of any number of the shrinkage brackets or the fixed connection supports. When the sponge cutting, the pressing device presses down and the sponge placed on the worktable, while the vacuum suckers contacts with the sponge. When the sponge material blocks needs to be distributed after the cutting, the vacuum suction device starts, the vacuum suckers firmly sucks the sponge material blocks at the corresponding position, and with the lifting and lowering of the pressing, device, the sponge material blocks are driven to move up and down, so as to achieve the object of material distribution. And the force in the horizontal direction will not generate during material distribution, and the sponge material blocks are arranged neatly after material distribution.

To further improve and refine the above technical solution, the material distributing device further includes a bottom frame, a machine frame and a pressing frame, and the vacuum suckers are evenly distributed on whole or partial portion of a bottom of the pressing frame, the vacuum suckers are connected to the independent vacuum suction devices through air pipes, the pressing frame is fixedly installed on the machine frame through a lifting mechanism, the machine frame is fixed on the bottom frame, and the lifting mechanism drives the pressing frame to move up and down, the transmission mechanism is arranged on the bottom frame, and the pressing frame is parallel to the transmission mechanism and is located above the transmission mechanism. When requiring to distribute and discharge the sponge material, the sponge material cut by the sponge cutting machine is delivered to the transmission mechanism. The lifting mechanism drives the pressing frame to press down, and the vacuum suckers contact the sponge material blocks at the corresponding position. At the same time, the vacuum suckers firmly suck the corresponding sponge material blocks under the function of the independent vacuum suction device, and the lifting, mechanism drives the pressing frame to drive the sponge material blocks to move up, so as to realize the object of the material distribution.

To further improve and refine the above technical solution, the machine frame includes four vertical frames arranged vertically on the bottom frame, the vertical frames are symmetrically distributed; the pressing frame includes a sliding frame symmetrically arranged and a plurality of pressing frame units arranged in parallel between the two sliding frames, a pressing frame unit on an outermost side is a fixed pressing frame unit, two ends of the fixed pressing frame unit are respectively connected to the same side ends of the two sliding frames, the rest of the pressing frame units are movable pressing frame units, the movable pressing frame units are slidably installed between the two sliding frames, the fixed pressing frame unit and the movable pressing frame units are foldably connected by a plurality of crossing connection rods, wherein the plurality of crossing connection rods are evenly arranged along the direction of the pressing frame unit, a first driving device is fixedly installed on the sliding frames, and the first driving, device and the crossing connection rods together drive the pressing frame unit to expand and contract, the sliding frames are fixedly installed on the vertical frame by a lifting mechanism, and the lifting mechanism drives the sliding frame to drive the pressing frame to move up and down, and the vacuum suckers are fixedly installed on a bottom of at least one of the pressing frame unit. The design of the pressing frame can expansion and contraction, cooperating with the vacuum suckers arranged on the pressing, frame unit, is convenient to realize the all-round suction of the sponge material blocks on the transmission mechanism.

To further improve and refine the above technical solution, the first driving device consists of a first motor, a pulley and a belt provided in cooperation with the first motor.

To further improve and refine the above technical solution, the pulley includes a main pulley and an auxiliary pulley, one side of the fixed pressing frame unit of the two sliding frame is mounted with the main pulley, and the other side thereof is mounted with the auxiliary pulley, the main pulley and the auxiliary pulley are connected by a belt, and the main pulleys are connected by a rotating shaft, one of the main pulleys is sleeved on an output shaft of the first motor, the first motor is fixedly installed on the sliding frame on the same side, and the belts are fixedly connected to the movable pressing frame units opposite to the fixed, pressing frame units, respectively. The first motor drives one main pulley to rotate, and drives the other main pulley to rotate synchronously through the rotating shaft. The main pulley drives the belt to move, and the belt drives the movable pressing, frame units on the opposite side of the fixed pressing frame unit to move, and drives all the movable pressing frame units to move synchronously to the side toward the fixed pressing frame unit or the reverse side of the fixed pressing frame unit by the crossing connecting rod, so as to realize the expansion and contraction of the pressing frame.

To further improve and refine the above technical solution, the lifting mechanism includes a second driving device, a guide rail and a slider; the guide rails are respectively provided vertically on the vertical frames, the guide rails are slidingly cooperate with the slider, the slider is fixedly installed on the pressing frame, the second driving device is fixedly installed on the vertical frame; the second driving device drives and is connected to pressing frame, and the second driving device drives the pressing frame to move up and down along the guide rail.

To further improve and refine the above technical solution, the second driving device consists of a second motor, a sprocket and a chain cooperated with the second motor.

To further improve and refine the above technical solution, the sprocket includes a main sprocket and an auxiliary sprocket, the vertical frame is a hollow square tube, the main sprocket and the auxiliary sprocket are fixedly installed at both ends of the vertical frame, the main sprocket and the auxiliary sprocket are located in the vertical frame and partially extend through the vertical frame, the main sprocket is located at an upper end of the vertical frame; the vertical frames are divided into two sets in symmetrical, the main sprockets on the same set of vertical frames are connected by a transmission shaft, a main sprocket is sleeved on the second motor, and the second motor is fixedly installed on the vertical frame. Two of the second motors rotate synchronously to drive all the main sprockets to rotate synchronously, so as to drive the chains to move up and down synchronously, and the chain drives the pressing frame to move up and down.

To further improve and refine the above technical solution, the transmission mechanism includes a conveyor belt, a conveyor bracket, a rotating shaft and a transmission motor; a plurality of rotating shafts are installed between the conveyor brackets, outer sides of the plurality of rotating shafts are installed between the conveyor brackets are wrapped with the conveyor belt, one end of one of the plurality of rotating shafts is connected to the transmission motor, the transmission motor is fixed on the conveyor bracket, the conveyor bracket is fixedly installed on the bottom frame; the transmission motor rotates to drive the rotation shaft to drive the conveyor belt to rotate.

The advantages of the present invention are that the design is reasonable and the structure, is simple, by using of the vacuum suckers to suck the sponge blocks at the corresponding position, and the lifting of the sponge blocks is driven b the lifting of the pressing frame, so as to realize the material distribution, and the material distribution is neat. For CN106625860A, a fully-automatic sponge cutting machine, which directly adds a vacuum sucker on its pressing device, does not affect its pressing function, but also increases the material distribution function, which occupies little space and has low cost.

### BRIEF DESCRIPTION OF THE DRAWINGS

FIG. 1 is a schematic view of the installation structure of a material distributing device for sponge cutting machine in Embodiment 1.

FIG. 2 is a front view of the material distributing device for sponge cutting machine in Embodiment 2.

FIG. 3 is a top view of the material distributing device for sponge cutting machine in Embodiment 2.

FIG. 4 is a lateral view of the material distributing device for sponge cutting machine in Embodiment 2.

FIG. 5 is a perspective view of the material distributing device for sponge cutting machine in Embodiment 2.

FIG. 6 is a front view of a transmission mechanism in Embodiment 2.

FIG. 7 is a perspective view of the transmission mechanism in Embodiment 2.

In the drawings: bottom frame 1; transmission mechanism 2; pressing frame 3; vertical frame 4; conveyor belt 5; conveyor bracket 6; rotating shaft 7; transmission motor 8; sliding frame 9; fixed pressing frame unit 10; movable pressing frame unit 11; crossing connection rod 12; first motor 13; rotating shaft 14; second motor 15; transmission shaft 16; vacuum sucker 17; automatic sponge cutting machine 18; pressing device 19.

### DETAILED DESCRIPTION OF THE EMBODIMENTS

### Embodiment 1

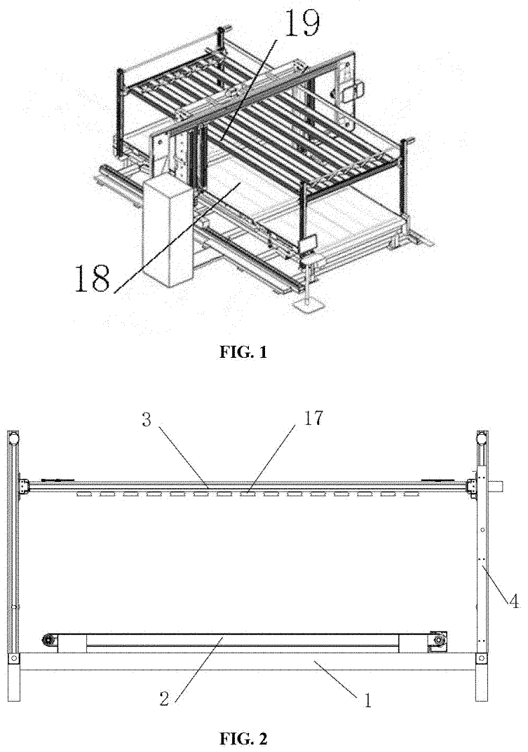

As shown in FIG. 1, a material distributing device for sponge cutting machine, including a plurality of vacuum suckers, wherein the vacuum suckers are respectively connected to the independently arranged vacuum suction device through air pipes, and cut sponge blocks are sucked by the vacuum suckers to conduct material distribution. The sponge cutting machine is a fully automatic sponge cutting machine 18, its patent application publication number: CN106625860A, the fully automatic sponge cutting machine 18 includes a pressing device 19. The pressing device includes a vertical bracket, a horizontal bracket, a guide rail, a slider, a rotating shaft, a transmission shaft, a driving motor, a pulley, a synchronous belt, and a shrinkage bracket. The lower end of the vertical bracket is connected to the worktable base, there are designed four vertical brackets and two the horizontal brackets. The two horizontal brackets are installed in parallel between the two adjacent vertical brackets. Vertical guide rails are installed on one side of the vertical bracket, vertical sliders are installed on both ends of the horizontal brackets, the vertical sliders are snapped in the vertical slide rails in sliding fit. The upper and lower ends of the vertical brackets are equipped with rotating shafts and the rotating shafts are equipped with pulleys, and the upper and lower ends of the pulleys are equipped around with the synchronous belt. One side of the synchronous belt is fixed to one side of the vertical slide rails, wherein the rotating shafts at the upper ends of the two vertical brackets on the adjacent side are connected by the transmission shaft, and the outer end of one of the rotating, shafts is connected to the driving motor. The driving motor is installed on the vertical bracket. A plurality of shrinkage brackets and one fixed connection support are provided between the two horizontal brackets. Two ends of the shrinkage bracket are provided with a horizontal slider, a horizontal guide rail is installed in the inside of the horizontal bracket. The two ends of the shrinkage bracket are snapped in the horizontal guide rail by the horizontal slider in sliding fit. The fixed connection support is fixed between the two horizontal brackets and is located in the same position of the one end of the two horizontal brackets. The positions near the two ends of the plurality of shrinkage brackets are respectively foldably connected to each other by a crossing connection rod, and the last end of the crossing connection rod is fixed on the fixed connection support. The rotating shafts are installed at both ends of the horizontal slide rails, and pulleys are installed on the rotating shafts. The synchronous belt is installed around the pulleys on the same horizontal slide rail, and one side of the synchronous belt is fixed to one side of the horizontal slider. The rotating shafts on one side of the two horizontal slide rails near the fixed connection support are connected to each other by the transmission shaft, and the transmission shaft passes through the fixed connection support. At the same time, one of the rotating shafts is equipped, with the driving motor at the outer side. The vacuum suckers are evenly arranged on bottoms of any number of the shrinkage brackets or the fixed connection supports. When the sponge is Cutting, the pressing device 19 presses down and the sponge placed on the worktable, while the vacuum suckers contacts with the sponge. When the sponge material blocks needs to be distributed after the cutting, the vacuum suction device starts, the vacuum suckers firmly sucks the sponge material blocks at the corresponding position, and with the lifting and lowering of the pressing device 19, the sponge material blocks are driven to move up and down, so as to achieve the object of material distribution. And the force in the horizontal direction will not generate during material distribution, and the sponge material blocks are arranged neatly after material distribution.

### Embodiment 2

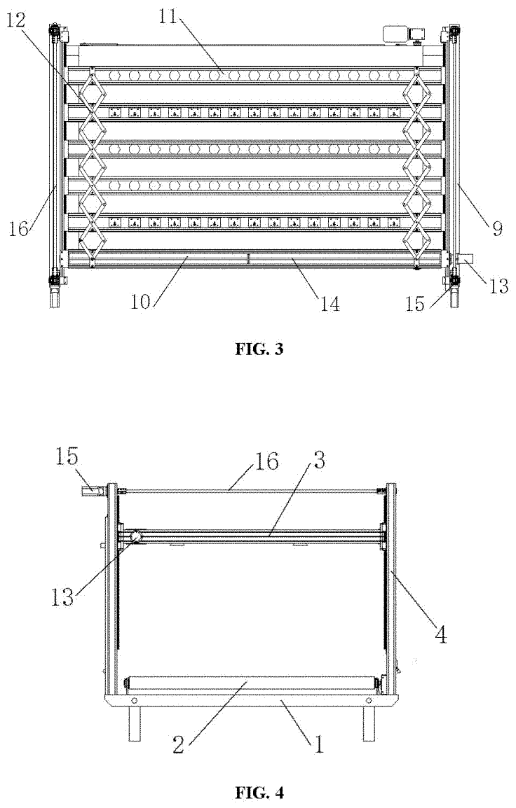

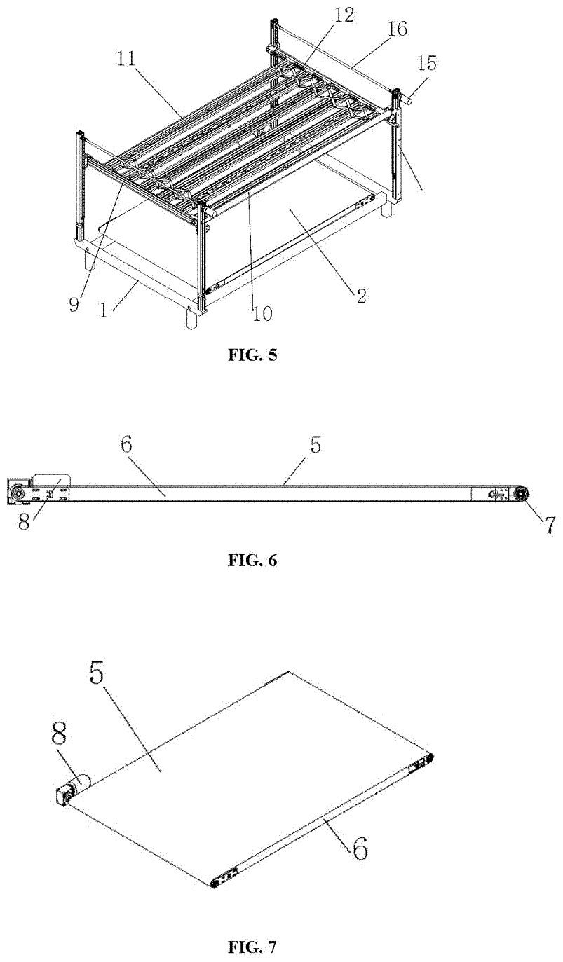

As shown in FIGS. 2-7, the material distributing device for sponge cutting machine further includes a plurality of vacuum suckers 17, a bottom frame 1, a machine frame and a pressing frame 3. The machine frame includes four, vertical frames 4 arranged vertically on the bottom frame, and the vertical frames 4 are symmetrically distributed. The pressing frame 3 includes a symmetrically arranged sliding frame 9 and a plurality of pressing frame units arranged in parallel between the two sliding frames 9, wherein a pressing frame unit on the outermost side is a fixed pressing frame unit 10, two ends of the fixed pressing frame unit 10 are respectively connected to the same side ends of the two sliding frames 9, the rest of the pressing frame units are movable pressing frame units 10, and the movable pressing frame units 11 are slidably installed between the two sliding frames 9, respectively. The fixed pressing frame unit 10 and the movable pressing frame units 11 are foldably connected by a plurality of crossing connection rods 12, wherein the plurality of crossing connection rods 12 are symmetrical arranged at two ends of the pressing frame unit. A driving device is fixed installed on the sliding frame 9, wherein the driving device includes the first driving device 13, a main pulley, an auxiliary pulley and a belt. One side of the fixed pressing frame unit of the two sliding frame 9 is mounted with the main pulley, the other side thereof is mounted with the auxiliary pulley, and the main pulley and the auxiliary pulley are connected by the belt. The main pulleys are connected by a rotating shaft 14, and one of the main pulleys is sleeved on the output shaft of the first motor 13. The first motor 13 is fixedly installed on the sliding frame 9 on the same side, and the belts are fixedly connected to the movable pressing frame units 11 opposite to the fixed pressing frame units, respectively. The first motor 13 drives one main pulley to rotate, and drives the other main pulley to rotate synchronously through the rotating shaft 14, and the main pulley drives the belt to move, and the belt drives the movable pressing frame units on the opposite side of the fixed pressing frame unit to move, and drives all the movable pressing frame units 11 to move synchronously to the side toward the fixed pressing frame unit or the reverse side of the fixed pressing frame unit by the crossing connecting rod 12, so as to realize the expansion and contraction of the pressing frame 3. The sliding frame 9 is fixed on the vertical frame 4 by the lifting mechanism, wherein the lifting mechanism includes a second driving device, a guide rail and a slider. The guide rails are respectively provided vertically on the vertical frames 4, and the guide rails are slidingly cooperate with the slider. The slider is fixedly installed on the pressing frame 3. The second driving device, includes a second motor 15, a main sprocket, an auxiliary sprocket and chains. The vertical frame 4 is a hollow square tube, and the main sprocket and the auxiliary sprocket are fixedly installed at both ends of the vertical frame 4. The main sprocket and the auxiliary sprocket are located in the vertical frame 4 and partially extend through the vertical frame 4. The main, sprocket is located at the upper end of the vertical frame 4, and the vertical frames 4 are divided into two sets, every two vertical frames are in symmetrical to the other two vertical frames. The main sprockets on the same set of vertical frames 4 are connected by a transmission shaft 16, and one main sprocket is sleeved on the second motor 15 and the second motor 15 is fixedly installed on the vertical frame 4. Two of the second motors 15 rotate synchronously to drive all the main sprockets to rotate synchronously, so as to drive the chains to move up and down, and the chain drives the pressing frame 3 to move up and down. The plurality of vacuum suckers 17 are evenly distributed on the bottom of the two movable pressing frame units 11, and there are a plurality of movable pressing frame units 11 between the two movable pressing frame units 11. The transmission mechanism 2 is provided on the bottom frame 1, and the pressing frame 3 and the transmission mechanism 2 are in parallel and the pressing frame 3 is above the transmission mechanism 2. The transmission mechanism 2 includes a conveyor belt 5, a conveyor bracket 6, a rotating shaft 7 and a transmission motor 8. A plurality of rotating shafts 7 are installed between the conveyor brackets 6, and the outer sides of the plurality of rotating shafts 7 are wrapped with the conveyor belt 5. One end of one of the plurality of rotating shafts 4 is connected to the transmission motor 8, and the transmission motor 8 is fixed on the conveyor bracket 6, and the conveyor bracket 6 is fixedly installed on the bottom frame 1. The transmission motor 8 rotates to drive the rotation shaft 7 to drive the conveyor belt 5 to rotate. The vacuum suckers 17 are aligned with the upper surface of the sponge material blocks placed on the transmission mechanism 2, and the vacuum suckers 17 are connected to the independent vacuum suction devices through air pipes.

Due to the limited expression of words, there are infinite concrete structures objectively. For those of ordinary skill in the art, without departing from the principles of the present invention, a number of improvements, modifications, or changes can also be made, or the above technical features can be combined in an appropriate manner, those improvements, modifications, changes or combinations, or the application of the inventive concepts and technical solutions without creative efforts to other occasions should be regarded as the scope of the present invention.

What is claimed is:

1. A material distributing device for sponge cutting machine, configured to distribute material for the sponge cutting machine, comprising, a plurality of vacuum suckers, wherein the vacuum suckers are respectively connected to the independently arranged vacuum suction device through air pipes, and cut sponge blocks are sucked by the plurality of vacuum suckers to conduct material distribution.

2. The material distributing device for sponge cutting machine according to claim 1, wherein the sponge cutting machine is a fully automatic sponge cutting machine, and the fully automatic sponge cutting machine comprises a pressing device; the pressing device comprises a vertical bracket, a horizontal bracket, a guide rail, a slider, a rotating shaft, a transmission shaft, a driving motor, a pulley, a synchronous belt, and a shrinkage bracket; a lower end of the vertical bracket is connected to the worktable base; there are designed four the vertical brackets and two the horizontal brackets; the two horizontal brackets are installed in parallel between the two adjacent vertical brackets; vertical guide, rails are installed on one side of the vertical bracket, vertical sliders are installed on both ends of the horizontal brackets, the vertical sliders are snapped in the vertical slide rails in sliding fit; upper and lower ends of the vertical brackets are equipped with rotating shafts and the rotating shafts are equipped with pulleys, upper and lower ends of the pulleys are equipped with the synchronous belt, one side of the synchronous belt is fixed to one side of the vertical slide rails, wherein the rotating shafts at upper ends of the two vertical brackets on adjacent side are connected by the transmission shaft, and an outer end of one of the rotating shafts to connected to the driving motor, the driving motor is installed on the vertical bracket, a plurality of shrinkage brackets and one fixed connection support are provided between the two horizontal brackets, two ends of the shrinkage bracket are provided with a horizontal slider, a horizontal guide rail is installed in an inside of the horizontal bracket, the two ends of the shrinkage bracket are snapped in the horizontal guide rail by the horizontal slider in sliding fit, the fixed connection support is fixed between the two horizontal brackets and is located in a same end of the two horizontal brackets, positions near ends of the plurality of shrinkage brackets are respectively foldably connected to each other by a crossing connection rod, and a last end of the crossing connection rod is fixed on the fixed connection support, the rotating shafts are installed at both ends of the horizontal slide rails, and pulleys are installed on the rotating shafts, the synchronous belt is installed around the pulleys on the same horizontal slide rail, one side of the synchronous belt is fixed to one side of the horizontal slider, the rotating shafts on one side of the two horizontal slide rails near the fixed connection support are connected to each other by the transmission shaft, and the transmission shaft passes through the fixed connection support, at the same time, one of the rotating shafts is equipped with the driving motor at an outer side, the vacuum suckers are evenly arranged on bottoms of any number of the shrinkage brackets or the fixed connection supports.

3. The material distributing device for sponge cutting machine according to claim 1, wherein the material distributing device further comprises a bottom frame, a machine frame and a pressing frame, and the vacuum suckers are evenly distributed on whole or partial portion of a bottom of the pressing frame, the vacuum suckers are connected to the independent vacuum suction devices through air pipes, the pressing frame is fixedly installed on the machine frame through a lifting, mechanism, the machine frame is fixed on the bottom frame, and the lifting mechanism drives the pressing frame to move up and down, the transmission mechanism is arranged on the bottom frame, and the pressing frame is parallel to the transmission mechanism and is located above the transmission mechanism.

4. The material distributing device for sponge cutting machine according to claim 3, wherein the machine frame comprises four vertical frames arranged vertically on the bottom frame, the vertical frames are symmetrically distributed; the pressing frame comprises a sliding frame symmetrically arranged and a plurality of pressing frame units arranged in parallel between the two sliding frames, a pressing frame unit on an outermost side is a fixed pressing frame unit, two ends of the fixed pressing frame unit are respectively connected to same side ends of the two sliding frames, the rest of the pressing frame units are movable pressing frame units, the movable pressing frame units are slidably installed between the two sliding frames, the fixed pressing frame unit and the movable pressing frame units are foldably connected by a plurality of crossing connection rods, wherein the plurality of crossing connection rods are evenly arranged along the direction of the pressing frame unit, a first driving device is fixedly installed on the sliding frames, and the first driving device and the crossing connection rods together drive the pressing frame unit to expand and contract, the sliding frames are fixedly installed on the vertical frame by a lifting mechanism, and the lifting mechanism drives the sliding frame to drive the pressing frame to move up and down, and the vacuum suckers are fixedly installed on a bottom of at least one of the pressing frame unit.

5. The material distributing device for sponge cutting machine according to claim 4, wherein the first driving device comprises a first motor, a pulley and a belt provided in cooperation with the first motor.

6. The material distributing device for sponge cutting machine according to claim 5, wherein the pulley comprises a main pulley and an auxiliary pulley, one side of the fixed pressing frame unit of the two sliding frame is mounted with the main pulley; and the other side thereof is mounted with the auxiliary pulley, the main pulley and the auxiliary pulley are connected by a belt, and the main pulleys are connected by a rotating shaft, one of the main pulleys is sleeved on an output shaft of the first motor, the first motor is fixedly installed on the sliding frame on the same side, and the belts are fixedly connected to the movable pressing frame units opposite to the fixed pressing frame units, respectively.

7. The material distributing device for sponge cutting machine according to claim 4, wherein the lifting mechanism comprises a second, driving device, a guide rail and a slider; the guide rails are respectively provided vertically on the vertical frame, the guide rails are slidingly cooperate with the slider, the slider is fixedly installed on the pressing frame, the second driving device is fixedly installed on the vertical frame; the second driving device drives and is connected to pressing frame, and the second driving device drives the pressing frame to move up and down along the guide rail.

8. The material distributing device for sponge cutting machine according to claim 7, wherein the second driving device consists of a second motor, a sprocket and a chain cooperated with the second motor.

9. The material distributing device for sponge cutting machine according to claim 8, wherein the sprocket comprises a main sprocket and an auxiliary sprocket, the vertical frame is a hollow square tube, the main sprocket and the auxiliary sprocket are fixedly installed at both ends of the vertical frame, the main sprocket and the auxiliary sprocket are located in the vertical frame and partially extend through the vertical frame, the main sprocket is located at an upper end of the vertical frame; the vertical frames are divided into two sets, in symmetrical, every two vertical frames are in symmetrical to the other two vertical frames, the main sprockets on the same set of vertical frames are connected by a transmission shaft, a main sprocket is sleeved on the second motor, and the second motor is fixedly installed on the vertical frame.

10. The material distributing device for sponge cutting machine according to claim 3, wherein the transmission mechanism comprises a conveyor belt, a conveyor bracket, a rotating shaft, and a transmission motor; a plurality of rotating shafts are installed between the conveyor brackets, outer sides of the plurality of rotating shafts are installed between the conveyor brackets are wrapped with the conveyor belt, one end of one of the plurality of rotating shafts is connected to the transmission motor, the transmission motor is fixed on the conveyor bracket, the conveyor bracket is fixedly installed on the bottom frame; the transmission motor rotates to drive the rotation shaft to drive the conveyor belt to rotate.
